(19) United States
(12) Patent Application Publication
(10) Pub. No.: US 2026/0323290 A1
(43) Pub. Date: Oct. 15, 2026

(54) PRE-ASSOCIATION SECURITY NEGOTIATION (PASN) BETWEEN ACCESS POINTS (APS) OF A MULTI-AP COORDINATION (MAPC) CORDINATION GROUP

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(73) Assignee: Cisco Technology, Inc., San Jose, CA (US)

(21) Appl. No.: 19/543,241

(22) Filed: Feb. 18, 2026

Related U.S. Application Data
(63) Continuation of application No. 19/281,355, filed on Jul. 25, 2025.
(60) Provisional application No. 63/789,102, filed on Apr. 15, 2025.

(51) Int. Cl. H04W 12/069; H04W 12/037; H04W 12/041

(52) U.S. Cl. CPC H04W 12/069; H04W 12/037; H04W 12/041

(57) ABSTRACT

Pre-Association Security Negotiation (PASN) between Access Points (APs) for Multi-AP Coordination (MAPC) be provided. A first AP of a MAPC Coordination Group (MAPC GC) may signal a support for an AP to AP (AP2AP) PASN. The first AP may perform PASN message exchange with a second AP of the MAPC for an AP2AP authentication with the second AP. The first AP may encrypt MAPC frames being exchanged between the first AP and the second AP using a key generated from the PASN exchange.

### RELATED APPLICATION

Proposed application is a continuation of U.S. patent application Ser. No. 19/281,355, filed Jul. 25, 2025, which claims the benefit of U.S. Provisional Application No. 63/789,102, filed Apr. 15, 2025.

### TECHNICAL FIELD

The present disclosure relates generally to Pre-Association Security Negotiation (PASN) between Access Points (APs) of a Multi-AP Coordination (MAPC) Coordination Group (MAPC CG).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Pre-Association Security Negotiation (PASN) between Access Points (APs) of a Multi-AP Coordination (MAPC) Coordination Group (MAPC CG);

FIG. 2A is a flow chart of a method for PASN between APs of a MAPC CG;

FIG. 2B illustrates example signaling diagram for a PASN authentication between a first AP and a second AP; and

FIG. 3 is a block diagram of a computing device.

### DETAILED DESCRIPTION

### Overview

Pre-Association Security Negotiation (PASN) between Access Points (APs) of Multi-AP Coordination (MAPC) may be provided. A first AP of a Multi-Access Point Coordination (MAPC) Coordination Group (MAPC CG) may receive a signal indicating a support for AP to AP (AP2AP) PASN from a second AP of the MAPC CG. The first AP may perform PASN message exchange with the second AP of the MAPC CG for an AP2AP authentication with the second AP. The first AP may encrypt MAPC frames being exchanged between the first AP and the second AP using a key generated from the PASN message exchange.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11be (Wi-Fi 7) and the IEEE 802.11bn (Wi-Fi 8) standards, Multi-Access Point (AP) Coordination (MAPC) may be considered as one of the main features. MAPC may allow higher network densification and higher network performance while avoiding issues such as co-channel interference. There may be several MAPC modes of operation. MAPC modes may include, for example, Coordinated Spatial-Reuse (C-SR), Coordinated Time-Division-Multiple-Access (C-TDMA), Coordinated Frequency-Division-Multiple-Access (C-FDMA), and Coordinated Orthogonal-Frequency-Division-Multiple-Access (C-OFDMA). Ultra-High Reliability (UHR) may be discussing a number of solutions for MAPC, such as C-TDMA, Constrained Restricted Target Wake Time (C-RTWT), C-OFDMA, etc. In all these MAPC solutions, the APs may exchange signaling with each other to execute MAPC operation. For example, in C-RTWT, Restricted-Target Wake Time (R-TWT) schedules are exchanged between APs, so APs can respect Service Period (SP) start time for R-TWT schedules from other APs.

In a MAPC operation, APs may be managed by a same entity, for example, APs in an enterprise deployment, or by different entities, for example, APs in Multi-Dwelling Units (MDUs) or different stores in a mall. In some MAPC operations, APs may be unmanaged, for example, APs in neighborhood homes. When performing MAPC related signal exchanges, these APs may need to establish some trust and security context between them to be able to securely exchange MAPC messages, either integrity protected or encrypted. Establishing security context may be needed, for example, to avoid Denial of Service (DoS) and other forms of attacks from rogue APs.

Embodiments of the disclosure may provide processes to establish security context (with or without authentication) between APs that are participating in MAPC exchanges in a MAPC Coordination Group (MAPC CG). The processes may be based on extending Pre-association Security Negotiation (PASN) protocol between an AP to an AP (AP2AP). Currently the PASN protocol in the IEEE 802.11 baseline is defined between a station and an AP. For example, the PASN protocol is defined in the IEEE 802.11 baseline may allow a station to establish security context with an AP before associating with the AP. The PASN protocol may support a mode where two stations and an AP may not have any PMK established beforehand (non-RSNA mode) and they may use ephemeral keys to derive a Pairwise Transient Key (PTK). The PASN protocol may enable the two stations to establish a Pairwise Transient Key Security Association (PTKSA) using 3-message PASN handshake.

Embodiments of the disclosure may extend the PASN protocol to between two APs. For example, two APs that may want to support MAPC exchanges may establish AP2AP pairwise keys (for example, a PTK) and optionally configured with a shared Pairwise Master Key (PMK)) between them. The pairwise keys may then be used for secure exchange of MAPC frames (for example, control and management frames) between the two APs. The security for the MAPC related control and management frame exchanges may be achieved either through message integrity (for example, by adding a Message Integrity Code (MIC)) or through an encryption (similar to Protected Management Frames (PMF)).

In an example implementation, a PTK may be established between two APs using the PASN protocol that may be extended for AP2AP. A set of APs that coordinate with each other for MAPC may form a MAPC CG. In a network managed by one administrative domain, APs that belong to a given MAPC CG may be configured out-of-band. Similarly, across multiple managed administrative domains, APs that may belong to a given MAPC CG and are allowed to coordinate may be configured by an entity providing management across domains. A MAPC CG may be configured with a MAPC CG ID. A distributed approach may be adopted for APs on the same channel to form a MAPC CG. For example, an AP is implicitly part of and at the center of its own MAPC CG that may include a subset of all co-channel APs in its range. Thus, each AP may be at the center of its own MAPC CG. In such case, a MAPC CG ID may be a default ID (for example, ID 0 or another chosen ID number) or no explicit MAP CG ID may be used.

In some example deployments, explicit MAPC CG may not be formed, and each AP may be center of its own MAPC CG that may include all co-channels AP can hear. A PTK in the IEEE 802.11 baseline for PASN may be generated as:
PTK=KDF-HASH-NNN (PMK, “PASN PTK Derivation”, SPA ||BSSID||DHss) where:
KDF-HASH-NNN: may be a key derivation function using a hash algorithm and an output length NNN in bits;
PMK: may be derived from the PASN authentication;
PASN PTK Derivation: may be a label to separate this key derivation from others;
SPA: may be a STA Media Access Control (MAC) address;
BSSID: may be AP MAC address; and
DHss: may be the Diffie-Hellman shared secret computed from PASN exchange.

For a PTK generation for an AP2AP PASN, the SPA address in the IEEE 802.11 baseline may be replaced with the BSSID of an AP initiating the PASN first message. The BSSID in the AP2AP PASN may be the BSSID of an AP receiving the first PASN frame. In one embodiment, for the AP2AP PASN, APs that are part of the same MAPC CG may perform a pairwise PASN among themselves that may be tied to the MAPC CG to generate a PTK. The MAPC CG ID may be included in the PTK generation along with BSSIDs of the two APs. Thus, the PTK for AP2AP PASN may be generated as:
PTK=KDF-HASH-NNN (PMK, “AP2AP PASN PTK Derivation”, BSSID AP1||BSSID AP2||MAPC CG ID||DHss).

Thus, for the PTK generation for the AP2AP PASN, the SPA address in the baseline is replaced with the BSSID of the AP initiating the first PASN message (that is, BSSID AP1). The BSSID is the BSSID of the AP receiving the first PASN message (that is, BSSID AP2).

In an alternate embodiment, the MAPC CG ID may not be included in the PTK generation for the AP2AP PASN. In such embodiments, a PTK may be generated based on BSSIDs of AP1 and AP2 and a new AP2AP PASN specific string. The PTK for the AP2AP PASN, in such embodiments, may be generated as:
PTK=KDF-HASH-NNN (PMK, “PASN PTK Derivation”, BSSID AP1||BSSID AP2||DHss).

In some embodiments, a new Authentication Algorithm Number (AAN) may be defined for the AP2AP PASN in the baseline defined list of AANs. The first PASN frame may explicitly indicate that it is for an AP2AP PASN negotiation by either using the new AAN for the AP2AP PASN or by using another field in the first PASN frame (if a new AAN not defined for the AP2AP PASN). For example, the AP2AP PASN may be signaled in a PASN parameters element or in a Robust Security Network Element (RSNE), a Robust Security Network Extended Element (RSNXE), or by adding a new field or an element.

In some examples, an AP can be part of two (or more) different MAPC CGs. When performing PASN with another AP, such AP may use the MAPC CG ID for the MAPC CG for which the PASN negotiation is being performed. The first PASN frame may be extended to include the MAPC CG ID. For example, the MAPC GC ID may be included as a new field in the PASN Parameters or in the RSNE, RSNXE, or by adding a new field/element to signal the MAPC CG for which PASN is initiated.

APs that are part of a same administrative domain may have a common pre-shared key configured on them that may be used as PMK in the AP2AP PASN exchange. APs that are part of different managed administrative domains, may have a trust relationship between them that may establish a common PMK between them. The common PMK may be identified by a PMK Identifier (PMKID) and may be used when generating the PTK using the AP2AP PASN as per PTK generation process discussed above. For APs that may be part of different unmanaged groups and may not have any trust established among them, there may not be a PMK established. In such examples, the AP2AP PASN may generate a common PTK without authentication between APs.

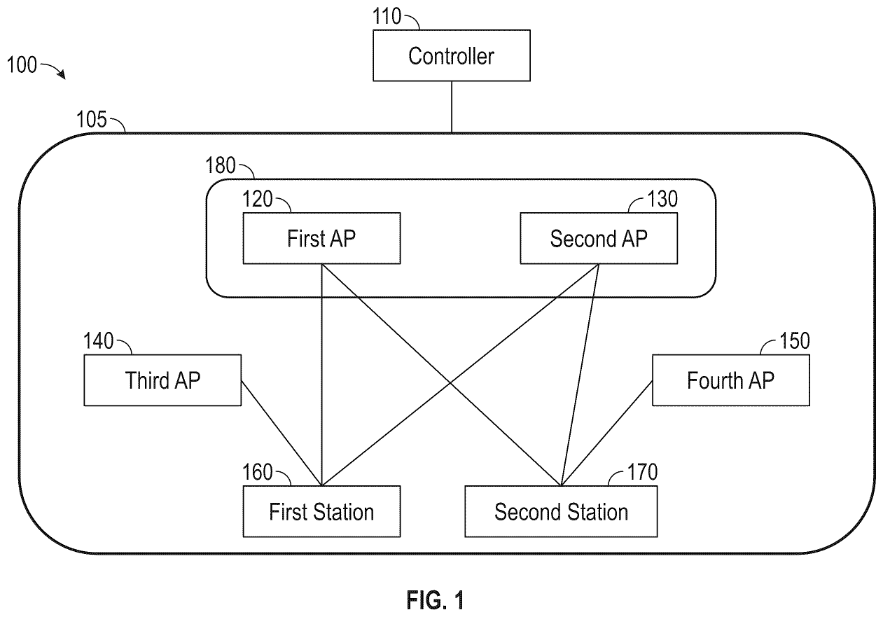

FIG. 1 is a block diagram of an operating environment 100 for PASN between APs for MAPC. Operating environment 100 may include a network 105 and a controller 110. Network 105 may include a plurality of network devices, for example, a plurality of APs (that is, a first AP 120, a second AP 130, a third AP 140, and a fourth AP 150) and a plurality of stations (that is, a first station 160 and a second station 170. Network 105 may further include a MAPC CG 180 that may include first AP 120 and second AP 130. Although MAPC GC 180 is shown to include only two APs, it can include more than two APs. Network 105 may be, but is not limited to, a WLAN. Network 105 may also be referred to as a coverage environment. Although MAPC GC 180 is shown to include only two APs, it can include more than two APs. Similarly, although network 105 is shown to include only one MAPC CG 180, it may include more than one MAPC GC.

Controller 110 may be a WLAN controller (WLC) and may provision and control network 105. Controller 110 may be implemented by a Digital Network Architecture Center (DNAC) controller (i.e., a Software-Defined Network (SDN) controller). Controller 110, first AP 120, second AP 130, third AP 140, and fourth AP 150 may provide a WLAN. Through this WLAN, first station 160 and second station 170 may be provided with access to the Internet or other cloud-based networking environments.

Each of first AP 120, second AP 130, third AP 140, and fourth AP 150 may be compatible with specification standards such as, but not limited to, the IEEE 802.11 specification standard for example. First AP 120, second AP 130, third AP 140, and fourth AP 150 may communicate with each other to conduct operations in concert. In addition, first AP 120, second AP 130, third AP 140, and fourth AP 150 may be devices that can send and receive signals to provide a connection to network 105.

First station 160 and second station 170 may communicate with one or more of first AP 120, second AP 130, third AP 140, and fourth AP 150. First station 160 and second station 170 may be, for example, an AP, a smart phone, a personal computer, a tablet device, a mobile device, a telephone, a remote control device, a set-top box, a digital video recorder, an Internet of Things (IoT) device, a cellular base station, a telephone, a remote control device, a set-top box, a digital video recorder, a cable modem, a network computer, a mainframe, a router, or other similar microcomputer-based device capable of accessing and using a Wi-Fi network.

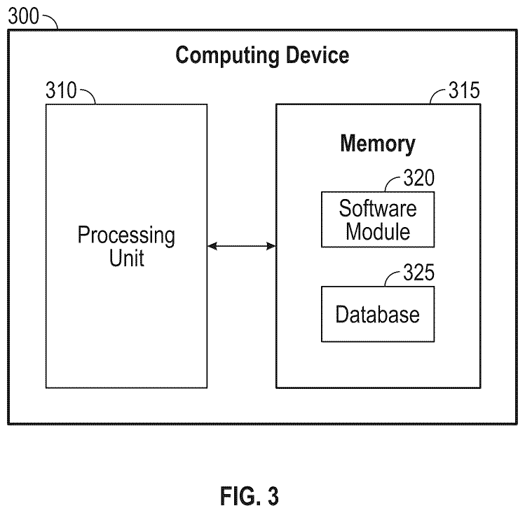

The elements described above of operating environment 100 (e.g., controller 110, first AP 120, second AP 130, third AP 140, fourth AP 150, first station 160, and second station 170) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

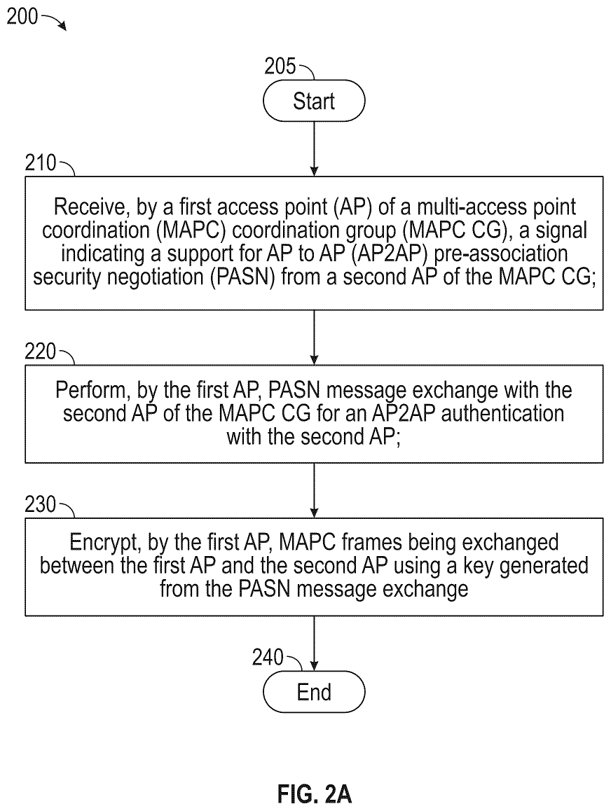

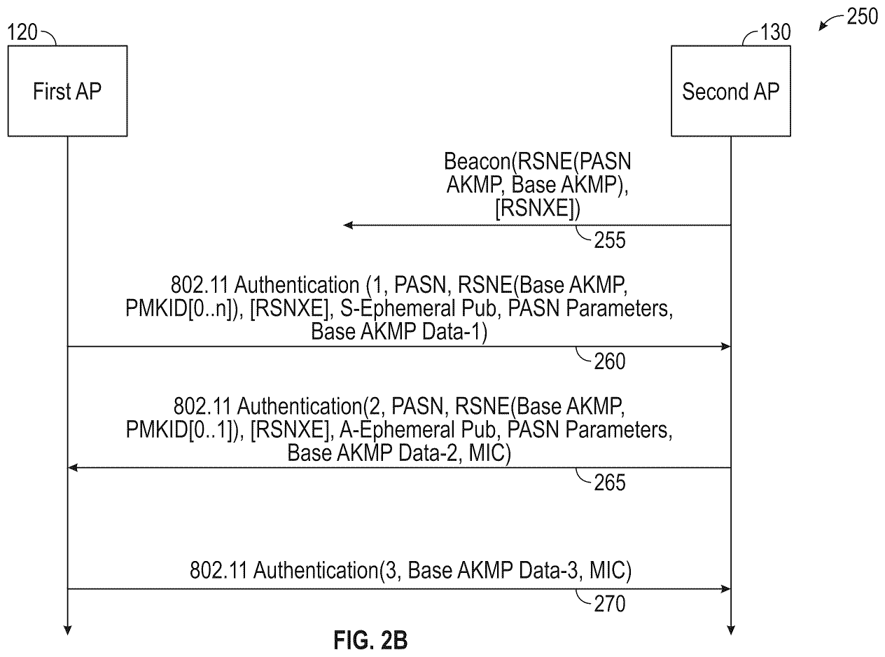

FIG. 2A is a flow chart setting forth the general stages involved in a method 200 consistent with embodiments of the disclosure for PASN between APs for MAPC. Method 200 may be implemented between first AP 120 and second AP 130 of MAPC GC 180 as described in more detail above with respect to FIG. 1. However, method 200 may also be implemented using any two of first AP 120, second AP 130, third AP 140, and fourth AP 150 as described in more detail above with respect to FIG. 1. Method 200 will be described in conjugation with an example signaling diagram 250 for PASN authentication of FIG. 2B. For example, FIG. 2B illustrates example signaling diagram 250 for PASN authentication between first AP 120 and second AP 130. Ways to implement the stages of method 200 will be described in greater detail below.

Method 200 may begin at starting block 205 and proceed to stage 210 where first AP 120 of MAPC CG 180 may receive a signal indicating a support for AP2AP PASN from second AP 130 of the MAPC CG 180. For example, as shown in operation 255 of signaling diagram 250 of FIG. 2B, second AP 130 may signal the support for the AP2AP PASN in a beacon, a probe response, or a management frame. Support for the AP2Ap PASN in one or more of these frames can be signaled using an element, sub-element, field, etc. in a RSNE or RNXE as a new Authentication and Key Management (AKM) defined for the AP2AP PASN. Similarly, first AP 120 may also signal a support for the AP2AP PASN in a beacon. In example implementations, each AP of MAPC CG 180 may signal a support for the AP2AP PASN in a beacon, a probe response, or a MAPC management frame using an element, sub-element, field, etc. in a RSNE or RNXE as a new AKM defined for the AP2AP PASN. In one example, the support for the AP2AP PASN may be signaled in a MAPC negotiation frame exchanged between the APs or in a MAPC discovery frame indicating AP capabilities for MAPC GC 180.

After receiving the signal indicating the support for AP2AP PASN from second AP 130 of the MAPC CG 180 at stage 210, method 200 may proceed to stage 220 where first AP 120 may perform PASN message exchange with second AP 130 of MAPC CG 180 for an AP2AP authentication and/or secure communication channel setup with second AP 130. For example, and as shown in shown in operation 260 of signaling diagram 250 of FIG. 2B, first AP 120 may send a first message (that is, a PASN authentication request or a first PASN frame). The PASN authentication request may include multiple elements, and each element may include different values. For example, the PASN authentication request may include an AP2AP PASN AAN (to indicate it is a message for the AP2AP PASN), one or more PMKID (identifying PMKs that can be used for the AP2AP PASN), a Diffie-Hellman public key value (or S-ephemeral pub) for first AP 120, PASN parameters, RSNE, RSNXE, PASN AKM, etc. Second AP 130 may generate a key PTK from the parameters received in the PASN authentication request. As discussed above, the PTK may be generated using the PMK, the BSSID AP1, the BSSID AP2, and the MAPC GC ID (if available).

The AP2AP authentication may be optional and may only be done if two APs may have some trusted key material setup, for example, out-of-band. In one example, a trusted PMK may be setup between two APs that may be used for the AP2AP authentication during the AP2AP PASN. In another example, a common PMK may be derived from another common keying material setup between the two APs. If no common PMK is established between the two APs, then the AP2AP PASN may not perform authentication between APs. In that case the AP2AP PASN may only set up security keys, for example, a TK using the AP2AP PASN procedure without authentication. In this example, Diffie-Hellman public/private keys may be used to generate a common DH shared secret that gets used for generating a TK.

First AP 120 may initiate AP2AP PASN 3-message exchange with second AP 150 with which it wants to perform MAPC exchanges only if second AP 130 signals support for AP2AP PASN in its beacon, a probe response, a MAPC frame, etc. The first PASN message may optionally include the MAPC CG ID. If MAPC CG ID is included in the first PASN message, second AP 130 may verify that it is part of the MAPC CG ID indicated in the first PASN message. Second AP 130 may also verify that the first PASN message received from first AP 120 is an AP2AP PASN message, for example, based on the new AAN for the AP2AP PASN included in the first message. For example, and as discussed above, the first PASN message may explicitly indicate that it is for an AP2AP PASN negotiation by either using a new AAN for AP2AP PASN or using another field in the first PASN frame (if a new AAN not defined for AP2AP PASN). For example, the AP2AP PASN may be signaled in the PASN parameters element or in the RSNE, RSNXE or by adding a new field or element.

In operation 265 of signaling diagram 250 of FIG. 2B, second AP 130 may send a second message (that is, a PASN authentication response). The PASN authentication response from second AP 130 may include an AP2AP PASN AAN, RSNE, RSNXE, PMKID, a Diffie-Hellman public key value (or A-ephemeral pub) for second AP 130, PASN parameters, AKM, etc. In addition, the PASN authentication response may include a MIC or may be encrypted and include a MIC. The MIC may be generated from the PTK. First AP 120 may generate the PTK from the parameters received in the PASN authentication response received from second AP 130. For example, and as discussed above, the PTK may be generated using the PMK (if available), the BSSID AP1, the BSSID AP2, and optionally the MAPC GC ID (if available and used). If a PMK is used for the AP2AP PASN, then the PASN exchange may also perform the AP2AP authentication. If no PMK is used for the AP2AP PASN, then the PASN exchange between APs may set up a key (for example, a PTK) for a secure communication channel between the APs without mutual authentication of APs.

In operation 270 of signaling diagram 250 of FIG. 2B, first AP 120 may send a confirmation message to second AP 130. The confirmation message or a PASN confirmation message may confirm key derivation and integrity using optional signature or a MIC and a MAC of the derived key exchange. Operation 270 may mark an end of PASN between first AP 120 and second AP 130 and may result in generation of the PTK. In examples, operations 260, 265, and 270 of signaling diagram 250 of FIG. 2B may also be referred to as 3-message PASN handshake. All messages of the AP2AP PASN exchange may use IEEE 802.11 authentication frames as is used for the PASN between a non-AP STA and an AP.

Once having performed the PASN message exchange with second AP 130 of MAPC CG 180 at stage 220, method 200 may proceed to stage 230 where first AP 120 may encrypt MAPC frames being exchanged between first AP 120 and second AP 130 using a TK (for example, a MIC) generated from the PASN exchange. The TK may be used for integrity protection or encryption of control frames and/or management frames exchanged between the two APs. In some examples, two different TKs may be generated as part of the AP2AP PTK, one used for integrity protection of certain frames and the other used for encryption of certain frames. After encrypting the MAPC frames being exchanged between first AP 120 and second AP 130 using the TK generated from the PASN exchange at stage 230, method 200 may terminate at END stage 240.

### MAPC Group Keys

The AP2AP PASN negotiation may also result in generating a common group key to be used by all APs of a given MAPC CG (that is, MAPC CG 180). For example, when first AP 120 initiates an AP2AP PASN negotiation with second AP 130 in a MAPC CG 180 for the first time, one of the two APs may generate a group key for MAPC CG 180. Later when two APs perform AP2AP PASN and one of the APs has a common group key for that MAPC CG, that AP may provide the group key to the other AP. This way, all the APs in MAPC CG 180 may get access to the common group key, which can be used for a group addressed frames addressed for all APs of MAPC CG 180.

In an embodiment, one of the APs in MAPC CG 180 may be designated as a leader AP, and the designated leader AP may generate the common group key and may also be responsible for re-keying of the common group key. When a common group key is regenerated by the leader AP, the leader AP may perform a group key handshake (2 messages exchange) with other APs in MAPC CG 180 to provide them with the common group key. Generation and distribution of the common group key may obviate a need for each AP pair in MAPC CG 180 deriving a PTK for the pair.

In examples, a PTK re-keying procedure may be defined to regenerate the AP2AP PTK between APs on the same MAP CG. Another 3-message AP2AP PASN exchange may be performed to generate a new AP2AP PTK, so a different set of messages may be defined for rekeying PTK between APs.

In another example, the AP2AP PTK may be established between the two APs participating in MAPC CG 180 using a new 3-frame exchange similar to the 3-message PASN exchange discussed above. The new 3-frame exchange may use a new ‘AP2AP authentication’ and a new AKM scheme for the AP2AP authentication and key generation, without tying it to PASN. The new AP2AP PTK may be generated as:
PTK=KDF-HASH-NNN (PMK, “AP2AP PTK Derivation”, BSSID AP1||BSSID AP2||MAPC CG ID||DHss)

In another embodiment, the new AP2AP PTK derivation can be only tied to BSSIDs of the two APs:
PTK=KDF-HASH-NNN (PMK, “AP2AP PTK Derivation”, BSSID AP1||BSSID AP2||DHss).

The procedure for establishing AP2AP PTK and group key for a MAPC CG may be similar as above without tying it with PASN.

FIG. 3 is a block diagram of a computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for PASN between APs for MAPC 180 described with respect to FIG. 2. Computing device 300, for example, may provide an operating environment for controller 110, first AP 120, second AP 130, third AP 140, fourth AP 150, first station 160, and second station 170, and the like. Controller 110, first AP 120, second AP 130, third AP 140, fourth AP 150, first station 160, and second station 170, and the like may operate in other environments and are not limited to computing device 300.

Computing device 300 may be implemented using an AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
initiating Multi-Access Point Coordination (MAPC) pre-association security negotiation (PASN) by a first access point (AP) by transmitting, by the first AP, a first PASN frame to a second AP, wherein the first PASN frame comprises a plurality of parameters including one or more base Authentication and Key Management Protocol (AKMP) parameters, one or more PASN parameters and a public key of the first AP;
receiving, by the first AP, a second PASN frame from the second AP, the second PASN frame comprising a public key of the second AP and a message integrity code (MIC), the MIC generated by the second AP based on a pairwise transient key (PTK);
deriving the pairwise transient key (PTK) using the Basic Service Set Identifier (BSSID) of the first AP and the BSSID of the second AP;
transmitting, by the first AP, a third PASN frame to the second AP, the third PASN frame including data confirming derivation of the PTK by the first AP; and
protecting MAPC frames exchanged between the first AP and the second AP based on the PTK.

1. The method of claim 1 wherein the BSSID of the first AP is a Media Access Control (MAC) address of the first AP and wherein the BSSID of the second AP is a MAC address of the second AP.

2. The method of claim 1 further comprising generating, by the first AP, a second MIC based on the PTK and one or more data attributes of the third PASN frame, wherein the data confirming derivation of the PTK by the first AP comprises the second MIC.

3. The method of claim 1 wherein the first PASN frame includes data indicating a pairwise master key.

4. The method of claim 1 wherein the first PASN frame comprises an authentication Algorithm Number indicating MAPC PASN Authentication.

5. The method of claim 1 wherein the first PASN frame comprises a Robust Security Network Element (RSNE) containing an authentication Algorithm Number indicating MAPC PASN Authentication and data indicating a pairwise master key.

6. The method of claim 1 wherein the second PASN frame further comprises a RSNE containing one or more chosen AKMP parameters.

7. The method of claim 1 further comprising receiving, by the first AP, a MAPC discovery frame from the second AP, the MAPC discovery frame indicating support for MAPC PASN.

8. The method of claim 1 wherein the PTK comprises an encryption key component and a message integrity key component.

9. An access point (AP) comprising:
one or more memories; and
one or more processors communicatively coupled to the one or more memories, wherein the one or more processors are configured to, individually or collectively, perform operations comprising:
initiating Multi-Access Point Coordination (MAPC) pre-association security negotiation (PASN) by transmitting, by the AP, a first PASN frame to a second AP, wherein the first PASN frame comprises a plurality of parameters including one or more base Authentication and Key Management Protocol (AKMP) parameters, one or more PASN parameters and a public key of the AP;
receiving, by the AP, a second PASN frame from the second AP, the second PASN frame comprising a public key of the second AP and a message integrity code (MIC), the MIC generated by the second AP based on a pairwise transient key (PTK);
deriving the pairwise transient key (PTK) using the Basic Service Set Identifier (BSSID) of the AP and the BSSID of the second AP;
transmitting, by the AP, a third PASN frame to the second AP, the third PASN frame including data confirming derivation of the PTK by the AP; and
protecting MAPC frames exchanged between the AP and the second AP based on the PTK.

10. The AP of claim 10, wherein the BSSID of the AP is a Media Access Control (MAC) address of the AP and wherein the BSSID of the second AP is a MAC address of the second AP.

11. The AP of claim 10, the operations further comprising generating, by the AP, a second MIC based on the PTK and one or more data attributes of the third PASN frame, wherein the data confirming derivation of the PTK by the AP comprises the second MIC.

12. The AP of claim 10 wherein the first PASN frame includes data indicating a pairwise master key.

13. The AP of claim 10 wherein the first PASN frame comprises an authentication Algorithm Number indicating MAPC PASN Authentication.

14. The AP of claim 10 wherein the first PASN frame comprises a Robust Security Network Element (RSNE) containing an authentication Algorithm Number indicating MAPC PASN Authentication and data indicating a pairwise master key.

15. The AP of claim 10 wherein the second PASN frame further comprises a RSNE containing one or more chosen AKMP parameters.

16. The AP of claim 10, the operations further comprising receiving, by the AP, a MAPC discovery frame from the second AP, the MAPC discovery frame indicating support for MAPC PASN.

17. The AP of claim 10 wherein the PTK comprises an encryption key component and a message integrity key component.

18. A non-transitory computer readable storage medium comprising instructions that when executed configure one or more processors of an access point (AP) to perform operations comprising:
initiating Multi-Access Point Coordination (MAPC) pre-association security negotiation (PASN) by transmitting, by the AP, a first PASN frame to a second AP, wherein the first PASN frame comprises a plurality of parameters including one or more base Authentication and Key Management Protocol (AKMP) parameters, one or more PASN parameters and a public key of the AP;
receiving, by the AP, a second PASN frame from the second AP, the second PASN frame comprising a public key of the second AP and a message integrity code (MIC), the MIC generated by the second AP based on a pairwise transient key (PTK);
deriving the pairwise transient key (PTK) using the Basic Service Set Identifier (BSSID) of the AP and the BSSID of the second AP;
transmitting, by the AP, a third PASN frame to the second AP, the third PASN frame including data confirming derivation of the PTK by the AP; and
protecting MAPC frames exchanged between the AP and the second AP based on the PTK.

19. The non-transitory computer readable storage medium of claim 19, wherein the BSSID of the AP is a Media Access Control (MAC) address of the AP and wherein the BSSID of the second AP is a MAC address of the second AP.

20. The non-transitory computer readable storage medium of claim 19, the operations further comprising generating, by the AP, a second MIC based on the PTK and one or more data attributes of the third PASN frame, wherein the data confirming derivation of the PTK by the AP comprises the second MIC.

21. The non-transitory computer readable storage medium of claim 19 wherein the first PASN frame includes data indicating a pairwise master key.

22. The non-transitory computer readable storage medium of claim 19 wherein the first PASN frame comprises an authentication Algorithm Number indicating MAPC PASN Authentication.

23. The non-transitory computer readable storage medium of claim 19 wherein the first PASN frame comprises a Robust Security Network Element (RSNE) containing an authentication Algorithm Number indicating MAPC PASN Authentication and data indicating a pairwise master key.

24. The non-transitory computer readable storage medium of claim 19 wherein the second PASN frame further comprises a RSNE containing one or more chosen AKMP parameters.

25. The non-transitory computer readable storage medium of claim 19, the operations further comprising receiving, by the AP, a MAPC discovery frame from the second AP, the MAPC discovery frame indicating support for MAPC PASN.

26. The non-transitory computer readable storage medium of claim 19 wherein the PTK comprises an encryption key component and a message integrity key component.
